(19) United States
(12) Patent Application Publication
(10) Pub. No.: US 2026/0264200 A1
(43) Pub. Date: Sep. 10, 2026

(54) HAND TOOL HAVING THREADED INTERCHANGEABLE GRIP

(71) Applicant: Stanley Black & Decker Inc., New Britain, CT (US)

(72) Inventor: David Engvall, Stanley, NC (US)

(73) Assignee: Stanley Black & Decker Inc., New Britain, CT (US)

(21) Appl. No.: 19/557,726

(22) Filed: Mar. 5, 2026

Related U.S. Application Data
(60) Provisional application No. 63/768,539, filed on Mar. 7, 2025.

(51) Int. Cl. B25B 23/16; B25B 13/46; B25G 3/30

(52) U.S. Cl. CPC B25B 23/16; B25B 13/46; B25G 3/30

(57) ABSTRACT

An interchangeable grip for a hand tool having for mounting on a tool handle and which facilitates a robust, serviceable connection between the interchangeable grip and the tool handle. The hand tool includes a handle that comprises a shaft; a selectively interchangeable grip body removably coupled to the shaft, the grip body having a forward end, an aft end, and a central bore extending through the forward end and the aft end configured to receive and cover at least a portion of the shaft; and an end cap removably coupled to the shaft and the grip body, the end cap having an end cap body received at the aft end of the grip body to couple and maintain the grip body on the shaft.

### CROSS-REFERENCE TO RELATED APPLICATIONS

The present application claims the benefit of priority to U.S. Provisional Patent Application No. 63/768,539 (filed on Mar. 7, 2025), the contents of which are hereby incorporated by reference in their complete entirety.

### TECHNICAL FIELD

One or more embodiments of the present disclosure relate generally to an interchangeable grip for a hand tool having for mounting on a tool handle and which facilitates a robust, serviceable connection between the interchangeable grip and the tool handle.

### BACKGROUND

Hand tools such as ratchets, drivers, wrenches, and similar manually operated implements generally include a handle with an outer grip that enables the user to apply torque or other forces during operation. Conventional grips are typically overmolded, adhesively bonded, or otherwise permanently affixed to the handle structure of the tool. While such permanent attachment methods can provide adequate durability, they also present several drawbacks. For example, should a grip become worn, damaged, or uncomfortable for a particular user, the entire tool must often be replaced or returned for warranty service, thereby increasing cost and downtime. Permanent grips further limit opportunities for user customization, such as the ability to change colors, textures, or grip geometries to suit personal preferences or specific applications.

Various attempts have been made to provide modular or replaceable grips; however, existing solutions generally fail to provide a connection that is both secure under operational torque loads and conveniently serviceable without the need for specialized tools. Many known attachment mechanisms involve complex fasteners or multi-component assemblies that increase manufacturing cost and assembly time. Others may allow for removal of the grip, but are unable to prevent undesired rotation, axial movement, or loosening of the grip during heavy use, reducing overall reliability.

Moreover, hand tools often operate in harsh environments where exposure to impact, chemicals, oils, or repetitive stresses accelerates deterioration of grip materials. Users who rely on these tools—such as mechanics, electricians, and field technicians—require a solution that supports fast replacement of the grip without compromising structural integrity or tool performance. There is a continuing need for hand tool assemblies that provide a robust, repeatable, and user-serviceable interface between the tool's shaft and a removable grip.

Accordingly, there remains a need in the art for an interchangeable grip system that can be securely mounted to a tool handle, resists rotational and axial movement during use, and may be quickly detached and replaced using simple manual operations. The present disclosure addresses these and other shortcomings in the art.

### SUMMARY

The present disclosure provides hand tools equipped with a removable and interchangeable grip system that enables rapid field replacement, customization, and maintenance without compromising structural integrity or tool performance. In various embodiments, the tool includes a handle having a shaft with a tapered profile that defines a tool region and a grip region, and an intermediate region incorporating an axial stop that positions and limits advancement of a grip body during installation.

The interchangeable grip body includes a central bore sized to receive and cover the grip region of the shaft. Internal features of the bore, such as ribs or grooves, interface with corresponding surfaces or axial grooves on the shaft to prevent rotational movement and to maintain a stable, non-slip engagement during high-torque operation. The grip body may be formed as a unitary structure or may include multiple interconnected sections.

The aft end of the shaft may include a set of external threads that engage internal threads of an end cap. The end cap includes an outer grooved surface that mates with corresponding internal grooves of the grip body, thereby securing the grip body to the shaft through a threaded, tool-free connection. This configuration allows the user to assemble or remove the grip by manually rotating the grip body relative to the shaft.

The grip body may include an aft contact face with radially oriented grooves that receive raised circumferential ribs of an end cap. A mechanical fastener, such as a flat head cap screw, passes through the end cap and engages threaded features at the distal end of the shaft. Tightening the fastener applies axial compression that centers, tensions, and locks the grip body in place, eliminating clearance tolerances and preventing axial or rotational movement during use.

In the present disclosure, a hand tool in accordance with a first example implementation comprises one or more of the following: a handle that comprises a shaft; a selectively interchangeable grip body removably coupled to the shaft, the grip body having a forward end, an aft end, and a central bore extending through the forward end and the aft end configured to receive and cover at least a portion of the shaft; and an end cap removably coupled to the shaft and the grip body, the end cap having an end cap body received at the aft end of the grip body to couple and maintain the grip body on the shaft.

In the present disclosure, a hand tool in accordance with a second example implementation comprises one or more of the following: a tool head; a shaft coupled to the tool head; a selectively interchangeable grip body configured for removable coupling to the shaft, the grip body having a forward end, an aft end, and a central bore extending through the forward end and the aft end configured to receive and cover at least a portion of the shaft; and a removable end cap having an end cap body configured for receipt at the aft end of the grip body to thereby couple and maintain the grip body on the shaft.

In the present disclosure, a hand tool in accordance with a third example implementation comprises one or more of the following: a shaft having a distal end that terminates into a plurality of external threads; a selectively interchangeable grip body removably coupled to the shaft, the grip body having a forward end, an aft end, and a central bore extending through the forward end and the aft end configured to receive and cover at least a portion of the shaft; and an end cap including an end cap body having: (i) an outer surface of the end cap body comprises a plurality of longitudinally extending external ribs operable to engage corresponding internal grooves of the central bore of the grip body and thereby secure the end cap body to the grip body; and (ii) a bore with a plurality of inner threads configured for engagement with the plurality of external threads of the shaft and thereby secure the shaft to the grip body.

In accordance with the hand tool, the shaft is tapered along a longitudinal axis thereof to define a tool region operable for coupling to a tool head and a grip region operable for removable coupling to the grip body. The shaft may include an intermediate region serving as a transition between the tool region and the grip region.

In accordance with the hand tool, an axial stop is arranged at the intermediate region to limit further longitudinal advancement of the grip body on the shaft and facilitate advancement of the grip body to an assembled position on the shaft. The axial stop may be formed to have an outer diameter that is greater than the outer diameter of the tool region. The axial stop may be further formed to have a structural profile that flares outwardly in a longitudinal direction to present a contact face that is in direct engagement with a forward contact face of the grip body in the assembled position of the grip body on the shaft.

In accordance with the hand tool, the grip region terminates into a plurality of external threads configured to threadingly engage corresponding internal threads at a bore of the end cap body to thereby secure the shaft in the central bore of the grip body.

In accordance with the hand tool, in an outer surface of the end cap body comprises a plurality of grooves extending along a longitudinal axis thereof to engage corresponding inner grooves of the central bore of the grip body to secure the end cap body in the central bore.

In accordance with the hand tool, the aft end of the grip body comprises an aft contact face that is oriented in a plane which is perpendicular relative to the longitudinal axis of the grip body. The aft contact face comprises a plurality of symmetrically-spaced radial grooves.

In accordance with the hand tool, the end cap body comprises a plurality of raised circumferential ribs extending radially outward therefrom that are spatially aligned with the radial grooves of the grip body for receipt therein. The end cap body further comprises an opening sized to receive a mechanical fastener to further maintain the connection between the shaft and the grip body. The mechanical fastener may comprise a flat head cap screw having a flat head cap screw that includes a head region that contacts an outer contact surface of the end cap body when the grip body is advanced to the assembled position on the shaft. The flat head cap screw may comprise a plurality of external threads that threadingly engage corresponding internal threads of a central bore at a distal end of the grip region to maintain an operating position of the shaft in the central bore of the grip body.

Across all example implementations, the end cap operates in cooperation with the grip body and shaft to ensure a robust, repeatable, and serviceable coupling that withstands operational torque loads. The system enables users to quickly detach a worn or damaged grip and replace it with a new or customized version without requiring specialized tools or returning the tool for servicing. The disclosed hand tool therefore provides enhanced reliability, extended service life, and expanded opportunities for user-selected customization.

### DRAWINGS

The various advantages of one or more exemplary embodiments will become apparent to one skilled in the art by reading the following specification and appended claims, and by referencing the following drawings, in which:

FIG. 1 illustrates a view of an example hand tool, in accordance with a first embodiment set forth, shown, and described herein.

FIG. 2 illustrates an exploded view of the example hand tool of FIG. 1.

FIG. 3 illustrate a partial, sectional view of the example hand tool of FIG. 1.

FIG. 4 illustrates a rear view of the example hand tool of FIG. 1.

FIG. 5 illustrates a partial, sectional view taken along B-B of FIG. 4.

FIG. 6 illustrate a partial, sectional view of the example hand tool of FIG. 1.

FIG. 7 illustrates a rear view of the example hand tool of FIG. 6.

FIG. 8 illustrates a rear, sectional view of the example hand tool of FIG. 1.

FIG. 9 illustrates a partial, sectional view taken along A-A of FIG. 6.

FIG. 10 illustrates a view of an example hand tool, in accordance with a second embodiment set forth, shown, and described herein.

FIG. 11 illustrates an exploded view of the example hand tool of FIG. 10.

### DESCRIPTION

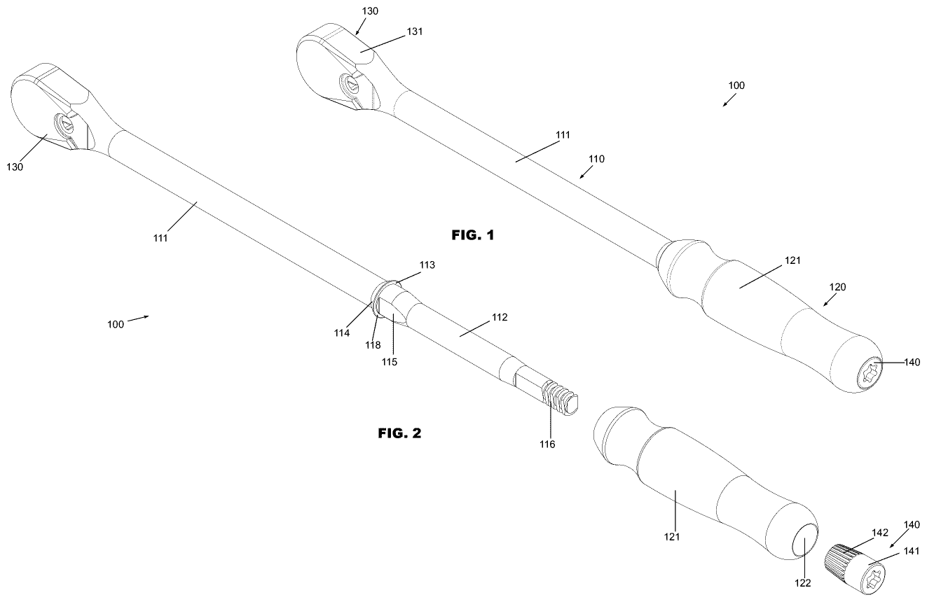

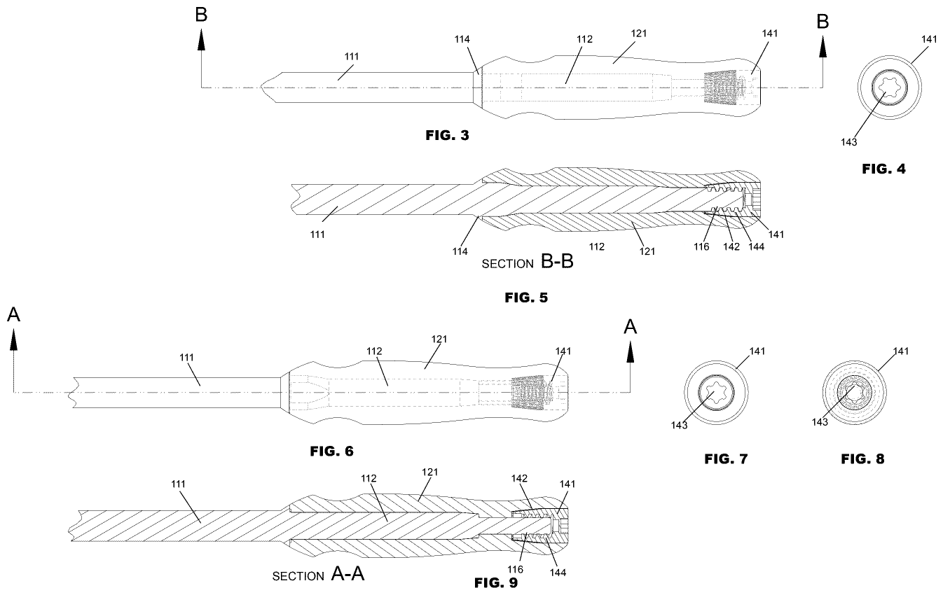

Turning to FIGS. 1 through 11, which illustrates example hand tools 100, 200 in accordance with one or more embodiments. Although the illustrated example embodiments show implementation of a hand tool comprising a ratchet tool, embodiments are not limited thereto. This disclosure contemplates the hand tool being implemented as any suitable hand tool that falls within the spirit and scope of the principles of this disclosure.

The example hand tools 100, 200 in accordance with one or more embodiments set forth, described, and/or illustrated herein comprises a removeable and interchangeable grip that enables the hand tools 100, 200 to be field-serviceable for damage repair or customization by quickly replacing the grip with another suitable grip.

The example hand tools 100, 200 may comprise one or more operational elements. Some of the possible operational elements of the hand tools 100, 200 are illustrated in the figures and will now be described. It will be understood that it is not necessary for the hand tools 100, 200 to incorporate all the elements illustrated in the figures set forth, and/or described herein. The hand tools 100, 200 may have any combination of the various elements illustrated herein. Moreover, the hand tools 100, 200 may have additional operational elements to those illustrated in the figures.

Each example hand tool 100, 200 comprises a handle 110, 210 comprising a shaft 111, a tool head 130 coupled to the handle 110, 210, and a removeable and interchangeable grip 120, 220 having a grip body 121, 221 with a gripping surface that enables a user to maintain a grip of the handle member 110, 210 when utilizing the tool to perform a specific tool function or task.

The shaft 111, 211 is tapered along a longitudinal axis thereof to define a tool region that is coupled to the tool head 130, 230 and a grip region 112, 212 that is removably coupled to the grip 120, 220.

The shaft 111, 211 may be formed by metal injection molding (MIM) that uses in whole or in part, a durable metal material. Such a durable metal material may comprise, for example, chrome. Embodiments, however, are not limited thereto, and thus, this disclosure contemplates the shaft 111, 211 being formed of any suitable material that falls within the spirit and scope of the principles of this disclosure. Although the illustrated example embodiment shows the shaft 111, 211 formed having a generally circular cross-sectional profile along its axial length, embodiments are not limited thereto. This disclosure contemplates the shaft 111, 211 formed having any suitable geometric cross-sectional profile that falls within the spirit and scope of the principles of this disclosure. For example, the shaft 111, 211 can be formed having a generally square cross-sectional profile, a generally rectangular cross-sectional profile, a generally oval cross-sectional profile, and any combinations thereof. In one example implementation of the shaft 111, 211, the cross-sectional profile of the grip region 112, 212 may, in whole or in part, have a generally rectilinear (square or rectangular) cross-sectional profile defining flat surfaces that correspond to the cross-sectional profile of a central bore 122, 222 of the grip body 121, 221. In another example implementation of the shaft 111, 211, the cross-sectional profile of the grip region 112, 212 may, in whole or in part, comprise a pair of opposing curvilinear sidewalls and a pair of opposing rectilinear sidewalls. The outer diameter of the shaft 111, 211 at the tool region is greater than the outer diameter of the shaft 111, 211 at the grip region 112, 212.

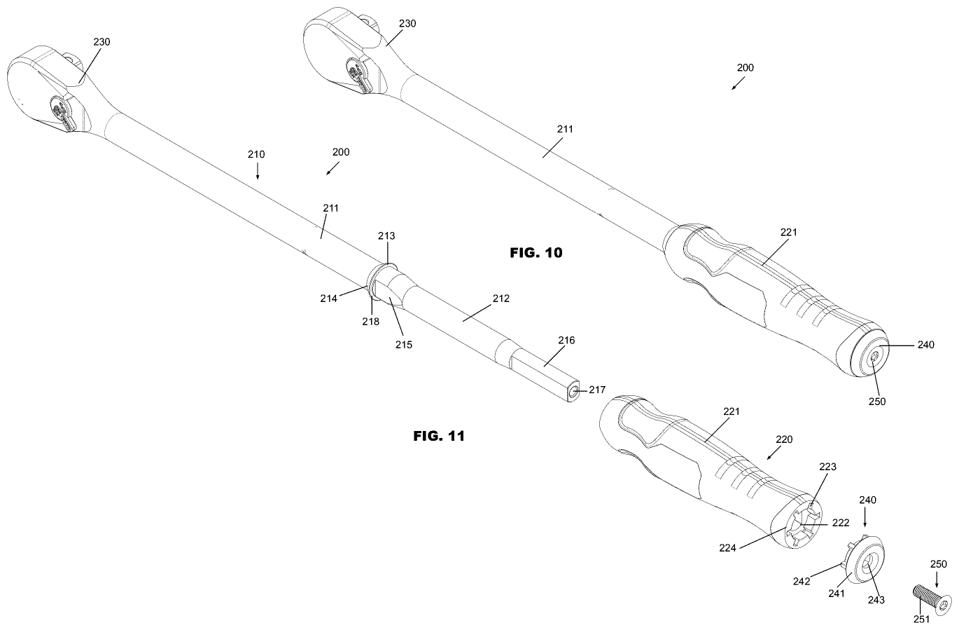

An intermediate region 113, 213 of the shaft 111, 211 serves as a transition between the tool region and the grip region 112, 212. The intermediate region 113, 213 includes an axial stop 114, 214 that limits further longitudinal advancement of the shaft 111, 211 when the grip body 121, 221 is advanced to a full operating or assembled position on the shaft 111 (FIGS. 1 and 10). The axial stop 114, 214 has an outer diameter that is greater than the outer diameter of the shaft 111, 211 at the tool region. The axial stop 114, 214 has a structural profile that flares outwardly in a longitudinal direction to present a contact face that is in direct engagement with a forward contact face of the grip body 121, 221 in the full operating or assembled position of the grip body 121, 221 on the shaft 111, 211. The outer surface of the intermediate region 113, 213 also includes locating grooves comprising one or more forward axial grooves 115, 215 that facilitate the mounting of the grip body 121, 221 thereon. The one or more forward axial grooves 115, 215 also prevent rotation of the grip body 121, 221 in the full operating or assembled position. Each forward axial groove 115, 215 is formed to have a profile or cross-section which interfaces with a corresponding forward internal rib of the grip body 121, 221 to actively tension the shaft 111, 211 and compensate for any clearance tolerances during assembly while also serving to prevent rotation of the grip body 121, 221 relative to the shaft 111, 211 during a tool operation.

In the example embodiments of FIGS. 1 through 9, the grip region 112 terminates into a plurality of threads 116 that threadingly engage corresponding inner threads 114 at a bore of an end cap body 141 (of an end cap 140) in a manner that secures the shaft 111 in the central bore 122 of the grip body 121. A user may secure the shaft 111 in the central bore 122 of the grip body 121 in a manner that connects the shaft 111 to the grip body 121 by rotating the grip body 121

An outer surface of the end cap body 141 includes a plurality of grooves 142 extending along a longitudinal axis thereof that engage corresponding inner grooves of the central bore 122 of the grip body 121 to secure the end cap body 141 in the central bore 122. The grooved connection between the grip body 121 and the end cap body 141 advantageously secures the shaft 111 to the grip body 121. This disclosure contemplates any suitable structural configuration to secure the end cap body 141 the central bore 122 of the grip body 121 the of the end cap body 116 that falls within the spirit and scope of the principles of this disclosure. Although the illustrated example embodiment shows the end cap body 116 comprising a flat head cap, embodiments are not limited thereto. This disclosure contemplates forming the end cap body 116 having any suitable structural configuration that falls within the spirit and scope of the principles of this disclosure.

Advantageously, the use of threaded connections does not necessitate the use of additional tools to assemble and disassemble the shaft 111 and the grip body 121. This advantageously allows the grip body 121 to be quickly removed for inspection, maintenance, and replacement.

The grip body 121 is formed as a unitary structure which, in an assembly position, covers or otherwise encapsulates the grip region 112 of the shaft 111. The central bore 122, extending at least substantially through the axial length of the grip body 121, has a diameter that corresponds to the outer diameter of the grip region 112 to facilitate receipt of the grip region 112 in the central bore 122. Although the illustrated embodiment shows the grip body 121 is formed as a unitary structure, embodiments are not limited thereto. This disclosure contemplates the grip body 121 being formed having any structural configuration that falls within the spirit and scope of the principles of this disclosure. For example, the grip body 121 may be formed having a plurality of interconnected grip body sections. Moreover, although the illustrated example embodiment shows the central bore 122 formed having a generally circular cross-sectional profile along its axial length, embodiments are not limited thereto. This disclosure contemplates the central bore 122 formed having any suitable geometric cross-sectional profile that falls within the spirit and scope of the principles of this disclosure. For example, the central bore 122 can be formed having a generally square cross-sectional profile, a generally rectangular cross-sectional profile, a generally oval cross-sectional profile, and any combinations thereof. In one example implementation of the grip body 121, the central bore 122 may, in whole or in part, have a generally rectilinear (square or rectangular) cross-sectional profile defining flat surfaces that correspond to the cross-sectional profile of the shaft 111. In another example implementation of the grip body 121, the cross-sectional profile of the central bore 122 may, in whole or in part, comprise a pair of opposing curvilinear sidewalls and a pair of opposing rectilinear sidewalls that correspond to the cross-sectional profile of the shaft 111.

In the example embodiments of FIGS. 10 and 11, the aft end of the grip body 221 includes an aft contact face 224 that is oriented in a plane which is perpendicular relative to the longitudinal axis of the grip body 221. The aft contact face 224 has a plurality of symmetrically-spaced radial grooves 223.

An annular washer or end cap 240 having an end cap body 241 is coupled to the aft end of the grip body 221 to facilitate securing of the grip body 221 on the shaft 211. The end cap body 241 includes a plurality of raised circumferential ribs 242 extending radially outward therefrom that are spatially aligned with the radial grooves 223 of the grip body 221 for receipt therein. The end cap body 241 also includes an opening 243 sized to receive a mechanical fastener 250 comprising a flat head cap screw 251. The flat head cap screw 251 further maintains the connection between the shaft 211 and the grip body 221. The flat head cap screw 251 includes a head region that contacts an outer contact surface of the end cap body 241 when the grip body 221 is advanced to a full operating or assembled position on the shaft 211 (FIG. 10). The flat head cap screw 251 further includes a plurality of external threads that threadingly engage corresponding internal threads of a central bore 217 at a distal end of the grip region 212 in a manner that facilitates securing of the shaft 211 in the central bore 222 of the grip body 221. The flat head cap screw 251 provides axial compressive force to retain the grip body 221 and remove any assembly clearance. A user may tighten the flat head cap screw 251, which simultaneously centers and tensions the grip body 221 onto the shaft 211 and takes up any clearance or stack-up tolerance between the grip body 221 and the shaft 211. After its tightening, the flat head cap screw 251 also prevents longitudinal movement between the shaft 211 and the grip body 221.

By virtue of the connection between the end cap body 141, 241 and the grip body 121, 221, and also the end cap body 141, 241 and the shaft 111, 211, rotation of the grip 120, 220 relative to the handle member 110 during a ratcheting operation is prevented. Should, during use, the grip 120, 220 becomes damaged, a user can easily and quickly replace the grip body 121, 221, a user may quickly and easily replace the grip 120, 220 with a replacement grip by selectively removing the aforestated connections, and manually separating the end cap body 141, 241 from the shaft 111, 211 and the grip body 121, 221. The grip body 121, 221 may then be separated from the shaft 111, 211 to enable its replacement with a replacement grip. A new grip body 121, 221 can then be fitted and the hand tool 100, 200 and returned to service without the need to warranty the entire hand tool 100, 200. Should a user want to change the visual appearance of hand tool 100, 200, the grip body 121 can also be interchanged with a similar grip body 121, 221 having a different aesthetic appearance, thereby allowing previously unavailable opportunity for customization by the user.

The terms “coupled,” “attached,” or “connected” can be used herein to refer to any type of relationship, direct or indirect, between the components in question, and can apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings and specification.

What is claimed is:

1. A hand tool, comprising:
a handle that comprises a shaft;
a selectively interchangeable grip body removably coupled to the shaft, the grip body having a forward end, an aft end, and a central bore extending through the forward end and the aft end configured to receive and cover at least a portion of the shaft; and
an end cap removably coupled to the shaft and the grip body, the end cap having an end cap body received at the aft end of the grip body to couple and maintain the grip body on the shaft.

2. The hand tool of claim 1, wherein the shaft is tapered along a longitudinal axis thereof to define a tool region operable for coupling to a tool head and a grip region operable for removable coupling to the grip body.

3. The hand tool of claim 2, wherein the shaft includes an intermediate region serving as a transition between the tool region and the grip region.

4. The hand tool of claim 3, further comprising an axial stop at the intermediate region to limit further longitudinal advancement of the grip body on the shaft and facilitate advancement of the grip body to an assembled position on the shaft.

5. The hand tool of claim 4, wherein the axial stop has an outer diameter that is greater than the outer diameter of the tool region.

6. The hand tool of claim 5, wherein the axial stop has a structural profile that flares outwardly in a longitudinal direction to present a contact face that is in direct engagement with a forward contact face of the grip body in the assembled position of the grip body on the shaft.

7. The hand tool of claim 2, wherein the grip region terminates into a plurality of threads that threadingly engage corresponding inner threads at a bore of the end cap body to thereby secure the shaft in the central bore of the grip body.

8. The hand tool of claim 1, wherein an outer surface of the end cap body comprises a plurality of grooves extending along a longitudinal axis thereof.

9. The hand tool of claim 8, wherein the plurality of grooves are configured to engage corresponding inner grooves of the central bore of the grip body to thereby secure the end cap body in the central bore.

10. The hand tool of claim 1, wherein the aft end of the grip body comprises an aft contact face oriented in a plane perpendicular to the longitudinal axis of the grip body.

11. The hand tool of claim 10, wherein the aft contact face comprises a plurality of symmetrically-spaced radial grooves.

12. The hand tool of claim 11, wherein the end cap body comprises a plurality of raised circumferential ribs extending radially outward therefrom.

13. The hand tool of claim 12, wherein the plurality of raised circumferential ribs are spatially aligned with and received in the radial grooves of the grip body.

14. The hand tool of claim 13, wherein the end cap body comprises an opening sized to receive a mechanical fastener to further maintain the coupling between the shaft and the grip body in the assembled position of the grip body on the shaft.

15. The hand tool of claim 14, wherein the mechanical fastener comprises a flat head cap screw.

16. The hand tool of claim 15, wherein the flat head cap screw comprises a flat head cap screw having a head region configured to engage an outer contact surface of the end cap body in the assembled position of the grip body on the shaft.

17. The hand tool of claim 16, wherein the flat head cap screw comprises a plurality of external threads.

18. The hand tool of claim 17, wherein the plurality of external threads are configured to threadingly engage corresponding internal threads of a central bore of the shaft at a distal end of the grip region to thereby maintain an operating position of the shaft in the central bore of the grip body.

19. A hand tool, comprising:
a tool head;
a shaft coupled to the tool head;
a selectively interchangeable grip body removably coupled to the shaft, the grip body having a forward end, an aft end, and a central bore extending through the forward end and the aft end configured to receive and cover at least a portion of the shaft; and
an end cap removably coupled to the shaft and the grip body, the end cap having an end cap body received at the aft end of the grip body to couple and maintain the grip body on the shaft.

20. A hand tool, comprising:
a shaft having a distal end that terminates into a plurality of external threads;
a selectively interchangeable grip body removably coupled to the shaft, the grip body having a forward end, an aft end, and a central bore extending through the forward end and the aft end configured to receive and cover at least a portion of the shaft; and
an end cap including an end cap body having:
an outer surface of the end cap body comprises a plurality of longitudinally extending external ribs operable to engage corresponding internal grooves of the central bore of the grip body and thereby secure the end cap body to the grip body; and
a bore with a plurality of inner threads configured for engagement with the plurality of external threads of the shaft and thereby secure the shaft to the grip body.
